(19) United States
(12) Patent Application Publication
(10) Pub. No.: US 2014/0001706 A1
(43) Pub. Date: Jan. 2, 2014

(54) WATERPROOF ROTATION MECHANISM AND RADAR ANTENNA DEVICE

(71) Applicant: Furuno Electric Co., Ltd., Nishinomiya (JP)

(72) Inventors: Koji Atsumi, Nishinomiya-shi (JP); Makoto Oda, Nishinomiya-shi (JP); Tomonori Watanabe, Nishinomiya-shi (JP); Yoshiki Nakamura, Nishinomiya-shi (JP); Hiroyuki Inada, Nishinomiya-shi (JP)

(21) Appl. No.: 13/930,837

(22) Filed: Jun. 28, 2013

(30) Foreign Application Priority Data
Jun. 29, 2012 (JP) 2012-146736

(51) Int. Cl. H01Q 1/12; F16J 15/447

(52) U.S. Cl. CPC H01Q 1/12; F16J 15/447
USPC 277/412; 277/345

(57) ABSTRACT

A waterproof rotary mechanism is provided. The mechanism includes a stationary part, a rotary part having a receiver arranged above the stationary part and rotatably supported by the stationary part on a vertical axis as a rotating center thereof, and a clearance forming part fixed to the stationary part and arranged between the stationary part and the receiver. A clearance for suppressing water from entering therein and is formed between the receiver and the clearance forming part.

### CROSS-REFERENCE TO RELATED APPLICATION(S)

The application claims priority under 35 U.S.C. §119 to Japanese Patent Application No. 2012-146736, which was filed on Jun. 29, 2012 the entire disclosure of which is hereby incorporated by reference.

### TECHNICAL FIELD

The present invention relates to a waterproof rotary mechanism that is a rotary mechanism having a waterproof structure, and a radar antenna device.

### BACKGROUND OF THE INVENTION

Radar apparatuses have been known as instrument for detecting the surroundings of a ship. The radar apparatus includes a radar antenna device arranged outside the ship. The radar antenna device has a stationary part, a rotational shaft, and an antenna. The stationary part supports the rotational shaft via a bearing. Thus, the rotational shaft can rotate about a vertical axis serving as a rotating center. The rotational shaft supports the antenna, and the antenna rotates about the vertical axis along with the rotational shaft. The antenna transmits radio waves and receives echo signals reflected on one or more target objects.

The radar antenna device is arranged outside the ship and may be accessible to water, such as sea water and rain. Therefore, a waterproof structure needs to be adopted so that water does not contact the bearing. JP1996-088164A ([0016]), JP1999-074718A (abstract), JP2005-053464A ([0078] and FIG. 4), and JP4519782B ([0016]) disclose such waterproof structures for devices having rotary mechanisms.

However, none of JP1996-088164A ([0016]), JP1999-074718A (abstract), JP2005-053464A ([0078] and FIG. 4), and JP4519782B ([0016]) is particularly taking a waterproof structure for a device that rotates about a vertical axis into consideration, and therefore, the configurations disclosed therein may not be able to exert sufficient waterproof effect in a mechanism having a rotary body that is rotatable about a vertical axis. Moreover, the waterproof effect is preferred to last for a long term in the mechanism having the rotary body that is rotatable about the vertical axis. Similar problem exists in devices having a rotary body that is rotatable about a vertical axis.

### SUMMARY OF THE INVENTION

The present invention is made in view of the above situation, and it provides a waterproof rotary mechanism having a rotary body that is rotatable about a vertical axis, and a radar antenna device that can exert sufficient waterproof effect for a long term.

According to an aspect of the invention, a waterproof rotary mechanism is provided. The device includes a stationary part, a rotary part, and a clearance forming part. The rotary part has a receiver arranged above the stationary part, and is rotatably supported by the stationary part on a vertical axis as a rotating center thereof. The clearance forming part is fixed to the stationary part and arranged between the stationary part and the receiver. A clearance for suppressing water from entering therein is formed between the receiver and the clearance forming part.

The clearance forming part may have a first inclining portion. The first inclining portion may be formed to extend downwardly toward outside in a radial direction of the rotary part.

The stationary part may have a second inclining portion arranged below the clearance forming part. The second inclining portion may be formed to extend downwardly toward outside in a radial direction of the rotary part.

The clearance formed between the receiver and the clearance forming part may extend in the vertical direction.

The receiver may have a first opposing portion, while the clearance forming part may have a second opposing portion. The second opposing portion may be arranged in parallel with the first opposing portion, and may form the clearance in conjunction with the first opposing portion. The second opposing portion may be arranged inward of the first opposing portion in a radial direction of the rotary part.

The clearance formed between the receiver and the clearance forming part may include a plurality of clearances.

The plurality of clearances may be formed in shapes of concentric circles centered at the vertical axis, respectively.

The waterproof rotary mechanism may further include an oil holder and a contact part. The oil holder may be arranged between the clearance forming part and the receiver and supported by the stationary part, and may hold oil therein. The contact part may be fixed to the receiver and contact the oil in the oil holder.

A part of the contact part may be arranged within the space in the oil holder. A labyrinth may be formed between the oil holder and the contact part.

The waterproof rotary mechanism may further include a drainage path formed by using the clearance forming part and the stationary part, and may discharge the water.

The drainage path may extend outwardly in a radial direction of the rotary part to be open to outside the waterproof rotation mechanism, and have a section having wider width in the vertical direction, toward inside in the radial direction of the rotary part.

According to another aspect of the invention, a radar antenna device is provided. The device includes the waterproof rotation mechanism of the above aspect of the invention, and an antenna fixed to the receiver and rotatable on the vertical axis as a rotating center thereof.

According to the present invention, sufficient waterproof effect of the waterproof rotary mechanism can last for a long term.

### BRIEF DESCRIPTION OF THE DRAWINGS

The present disclosure is illustrated by way of example and not by way of limitation in the figures of the accompanying drawings, in which the like reference numeral indicate like elements and in which:

FIG. 1 is a side view of a radar antenna device having a waterproof rotary mechanism according to one embodiment of the invention;

FIG. 2 is a cross-sectional view of the periphery of the waterproof rotary mechanism along a cross-sectional face in parallel with a vertical axis;

FIG. 3 is a cross-sectional view showing a main part of the waterproof rotary mechanism in an enlarged manner; and

FIG. 4 is a cross-sectional view showing the main part of the waterproof rotary mechanism illustrating the waterproof operation in a further enlarged manner.

### DETAILED DESCRIPTION

Hereinafter, embodiments for carrying out the present invention are described with reference to the appended drawings. Note that, the present invention can be applied broadly as a waterproof rotary mechanism.

### [Configuration of Radar Antenna Device]

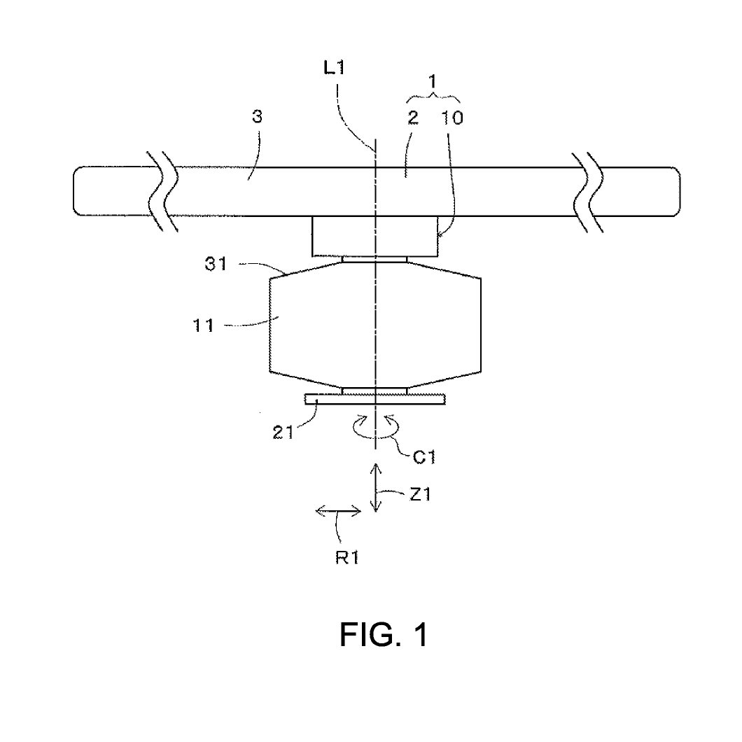

FIG. 1 is a side view of a radar antenna device having a waterproof rotary mechanism according to one embodiment of the invention. As shown in FIG. 1, the radar antenna device 1 of this embodiment is equipped in a ship (e.g., fishing boat). The radar antenna device 1 is mainly used for detecting one or more target objects (e.g., other ships). Note that, hereinafter, the description is given under a condition that the ship equipped with the radar antenna device 1 is floating on the waveless sea.

The radar antenna device 1 includes an antenna 2 and a waterproof rotary mechanism 10.

The antenna 2 is a radar antenna for transmitting pulse-shaped radio waves having strong directivity. Further, the antenna 2 receives echo signals that are reflection waves from one or more target objects. The antenna 2 is rotatable about a vertical axis L1 serving as a rotating central axis, by using a power from, for example, an electric motor (not illustrated). The antenna 2 repeatedly performs a transception of the pulse-shaped radio wave while changing a transmission direction of the radio wave (while changing an angle of the antenna). With this configuration, the radar antenna device 1 can detect the one or more target objects around the antenna 2 over 360° around the vertical axis L1.

Note that, hereinafter, each direction parallel with the vertical axis L1 may be referred to as “the vertical direction Z1.” Additionally, each direction around the vertical axis L1 may be referred to as “the circumferential direction C1.” Moreover, each direction perpendicular to the vertical axis L1 may be referred to as “the radial direction R1.”

The antenna 2 has a casing 3. The casing 3 is provided as an exterior member of the antenna 2. The casing 3 has a thin long shape extending in the horizontal direction. A central portion of the casing 3 in its longitudinal direction is supported by the waterproof rotary mechanism 10. The waterproof rotary mechanism 10 supports the antenna 2 to be rotatable about the vertical axis L1, and has a waterproof structure.

The waterproof rotary mechanism 10 has a housing 11 (stationary part).

The housing 11 is provided as a base member of the waterproof rotary mechanism 10. The housing 11 accommodates a magnetron (not illustrated) for producing pulse-shaped radio waves, etc. The housing 11 has a flange part 21 at its bottom. The flange part 21 is fixed to, for example, a mast (not illustrated) of the ship by using a fastener member, etc. A seal member is arranged between the flange part 21 and the mast. Thus, water is suppressed from entering inside the housing 11 from around the flange part 21.

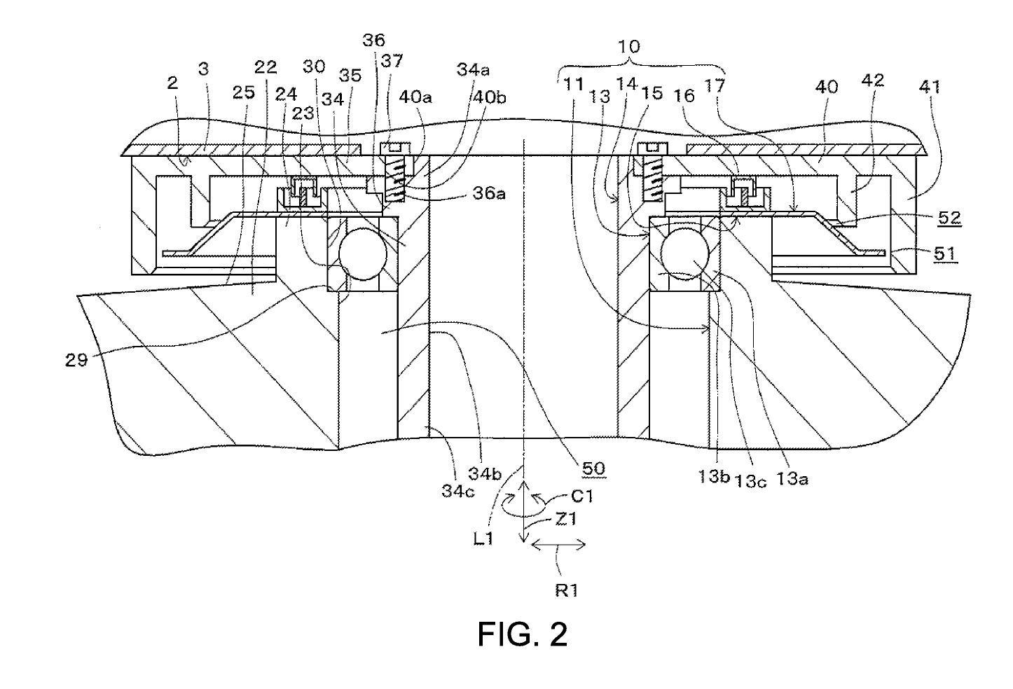

FIG. 2 is a cross-sectional view of the periphery of the waterproof rotary mechanism 10 along a cross-sectional face in parallel with the vertical axis L1. As shown in FIG. 2, an upper part 22 of the housing 11 has a space forming surface 23, an annular convex portion 24, and a second inclining surface 25.

The space forming surface 23 is formed to receive a rotational shaft 34 (described later) of the waterproof rotary mechanism 10 thereat. The space forming surface 23 extends in the vertical direction Z1. The space forming surface 23 is formed to have a cylindrical shape and has the vertical axis L1 in its center.

In an intermediate area of the space forming surface 23 in the vertical direction Z1, an annular step surface 29 is formed to face upwardly. A bearing holding surface 30 is formed continuously on the upper side to the step surface 29.

The bearing holding surface 30 is formed in a cylindrical shape. A lower end of the bearing holding surface 30 is continuous with an outer circumferential end of the step surface 29. The bearing holding surface 30 is formed in the annular convex portion 24 of the upper part 22 of the housing 11.

The annular convex portion 24 is provided to project upwardly from the second inclining surface 25. The annular convex portion 24 is formed in an annular shape centering on the vertical axis L1. The inner circumferential face of the annular convex portion 24 forms the bearing holding surface 30 described above. In other words, the annular convex portion 24 forms a part of the space forming surface 23. The second inclining surface 25 extends from an outer circumferential lower end of the annular convex portion 24.

The second inclining surface 25 faces upwardly. The second inclining surface 25 is arranged below a water blocking member 15 (described later). The second inclining surface 25 extends to incline with respect to the horizontal plane. Specifically, the second inclining surface 25 extends downwardly as, toward outside in the radial directions R1 from the annular convex portion 24. In other words, the second inclining surface 25 is formed in an umbrella shape. In this embodiment, the inclination of the second inclining surface 25 with respect to the horizontal plane is constant. An outer circumferential area 31 of the second inclining surface 25 (see FIG. 1) is open to outside in the radial directions R1. With this configuration, water that has reached on the second inclining surface 25 flows along the second inclining surface 25 outwardly in the radial directions R1 to be discharged outside the housing 11. The housing 11 having the above configuration forms a part of the waterproof rotary mechanism 10. The second inclining surface 25 is formed in the entire circumferential direction C1.

The waterproof rotary mechanism 10 has the housing 11, a bearing 13, a rotary body 14 (rotary part), the water blocking member 15 (clearance forming part), a labyrinth unit 16, and a drainage path 17.

The housing 11 supports the bearing 13.

The bearing 13 is provided to rotatably support the rotary body 14. The bearing 13 is a rolling bearing. In this embodiment, a ball bearing is used as the rolling bearing. Specific examples of the ball bearing include a deep groove ball bearing and an angular contact ball bearing.

The bearing 13 has an outer ring 13a, an inner ring 13b, and a rolling body 13c.

An outer circumferential face of the outer ring 13a is coupled (fitted) to the bearing holding surface 30 by being fixed with press-fitting, for example. A lower end of the outer ring 13a is received by the step surface 29. With this configuration, the outer ring 13a is positioned with respect to the vertical directions Z1. The outer ring 13a holds the inner ring 13b via the rolling body 13c (e.g., a ball). An inner circumferential face (the surface closer to the vertical axis L1) of the inner ring 13b is fixed to an outer circumferential face of the rotary body 14.

The rotary body 14 is provided to rotate integrally with the antenna 2, about the vertical axis L1 serving as the rotating center. Specifically, the rotary body 14 rotates about the vertical axis L1 as its rotational axis. The rotary body 14 is formed in a substantially annular shape. The radial direction R1 corresponds to the radial direction of the rotary body 14. The rotary body 14 is formed to have a T-shape in the cross sectional face in FIG. 2 (cross-sectional face containing the vertical axis L1). A part of the rotary body 14 is arranged in a space 50 (described later) of the space forming surface 23, and other part of the rotary body 14 is arranged outside the housing 11.

The rotary body 14 has the rotational shaft 34 and a receiver 35.

The rotational shaft 34 is coupled to the bearing 13. The rotational shaft 34 is formed in a substantially annular shape and is hollow. A lower portion 34c and intermediate portion 34b of the rotational shaft 34 are arranged in the space 50 of the space forming surface 23. The upper portion 34a of the rotational shaft 34 projects from the housing 11.

A wave guide tube (not illustrated) is arranged inside the rotational shaft 34. The pulse-shaped radio wave transmitted from the magnetron (not illustrated) described above passes the wave guide tube and is outputted to the antenna 2. An outer circumferential face of the intermediate portion 34b of the rotational shaft 34 is fitted to the inner circumferential face of the inner ring 13b of the bearing 13. With this configuration, the rotational shaft 34 is supported by the housing 11 via the single bearing 13 and can rotate about the vertical axis L1. The upper portion 34a of the rotational shaft 34 is integrally provided with a flange portion 36.

The flange portion 36 is formed in an annular shape. A lower end of the flange portion 36 is received by an upper end of the inner ring 13b. The receiver 35 is fixed to the flange portion 36.

The receiver 35 receives the casing 3 of the antenna 2 and is fixed to the casing 3. The receiver 35 is arranged at the upper portion 34a of the rotational shaft 34, which is on the housing 11. Moreover, the receiver 35 is arranged to cover a part of the upper part 22 of the housing 11. The receiver 35 is formed in an annular shape. The receiver 35 is made of metal, such as stainless.

The receiver 35 has a top plate 40 and a plurality of annular walls.

The top plate 40 is provided as a top lid of the waterproof rotation mechanism 10. The top plate 40 forms a top end portion of the waterproof rotation mechanism 10. The top plate 40 is formed in a circular disc centered at the vertical axis L1. A through hole 40a is formed in an central portion of the top plate 40. The through hole 40a extends to reach the upper portion 34a of the rotational shaft 34. An inner circumferential portion of the top plate 40 is received by the flange portion 36. The inner circumferential portion of the top plate 40 uses fastening members 37 serving as fixing members, to be fixed to the flange portion 36. Specifically, the inner circumferential portion of the top plate 40 is formed with a plurality of through holes 40b. The through holes 40b are arranged at equal intervals in the circumferential directions C1. Moreover, a plurality of fastening holes 36a are formed in a top face of the flange portion 36. Each of the fastening members 37 is inserted into each of the through holes 40b. The fastening member 37 is threadedly coupled to the corresponding fastening hole 36a. With the above configuration, the top plate 40 is integrally coupled to the rotational shaft 34.

The top plate 40 covers from above, the space 50 formed by the space forming surface 23, in conjunction with the flange portion 36. Additionally, the top plate 40 covers from above, a part of the second inclining surface 25 of the housing 11 and the annular convex portion 24 of the housing 11. A top surface of the top plate 40 faces upwardly and extends horizontally. A bottom surface of the top plate 40 extends in parallel with the top surface and faces downwardly. The bottom surface is continuous with the plurality of annular walls 41, 42.

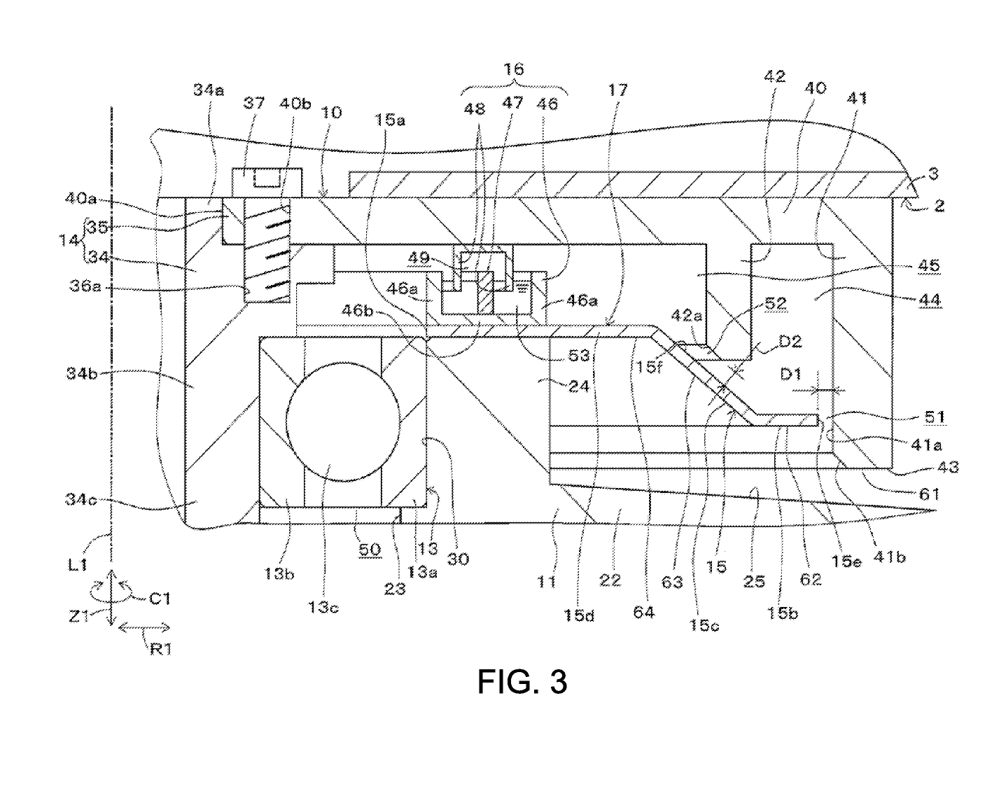

FIG. 3 is a cross-sectional view showing a main part of the waterproof rotation mechanism 10 in an enlarged manner. As shown in FIG. 3, the plurality of annular walls 41, 42 are provided to form a plurality of clearances in conjunction with the water blocking member 15. The plurality of clearances suppress water from entering therein.

The plurality of clearances include a first clearance 51 and a second clearance 52. The clearances 51 and 52 are formed between the receiver 35 and the water blocking member 15 and arranged concentrically centered at the vertical axis L1. The plurality of annular walls 41, 42 are arranged concentrically centered the vertical axis L1. In this embodiment, the plurality of annular walls 41, 42 and the top plate 40 are integrally formed using a single material.

The plurality annular walls include a first annular wall 41 and a second annular wall 42.

The first annular wall 41 is provided to form the first clearance 51. The first annular wall 41 extends downwardly from an outer circumferential portion of the top plate 40 along the vertical direction Z1. The first annular wall 41 is formed in an annular shape. The first annular wall 41 is arranged to surround the annular convex portion 24. A lower end of the first annular wall 41 is opposed to the second inclining surface 25 of the housing 11 in the vertical direction Z1. The lower end of the first annular wall 41 and the second inclining surface 25 form a gateway 43 for fluid to enter and exit, in conjunction with each other. Water (e.g., sea water and rain) can pass through the gateway 43 to reach outside/inside the waterproof rotation mechanism 10.

The inner circumferential face of the first annular wall 41 has a first opposing area 41a and a chamfered area 41b. The first opposing area 41a is provided to form the first clearance 51 in conjunction with a second opposing area 15e (described later) of the water blocking member 15. The first opposing area 41a is formed in a lower portion of the first annular wall 41 and surrounds the water blocking member 15. The chamfered area 41b is arranged below the first opposing area 41a. The chamfered area 41b inclines downwardly, toward outside in the radial direction R1. The first annular wall 41 having the above configuration surrounds the second annular wall 42.

The second annular wall 42 is provided to form the second clearance 52. The second annular wall 42 extends downwardly from the outer circumferential portion of the top plate 40 along the vertical directions Z1. The second annular wall 42 is formed in a cylindrical shape. The second annular wall 42 is arranged to surround the annular convex portion 24. A lower end portion of the second annular wall 42 is opposed to an upper end portion of the annular convex portion 24 in the radial directions R1. Regarding the vertical directions Z1, the length of the second annular wall 42 is shorter than the length of the first annular wall 41.

A lower portion of the second annular wall 42 has a third opposing area 42a. The third opposing area 42a is provided to form the second clearance 52, in conjunction with a fourth opposing area 15f (described later) of the water blocking member 15. In this embodiment, the third opposing area 42a is a chamfered area formed in an inner circumferential surface of the lower end portion of the second annular wall 42. The third opposing area 42a inclines upwardly, toward inside in the radial direction R1. The second annular wall 42 having the above configuration surrounds the labyrinth unit 16. The water blocking member 15 is arranged adjacent to the second annular wall 42.

The water blocking member 15 suppresses water from entering between the receiver 35 and the water blocking member 15, in conjunction with the receiver 35. The water blocking member 15 is arranged between the housing 11 and the receiver 35, above the second inclining surface 25. The water blocking member 15 is made of synthetic resin or metal, etc. The water blocking member 15 is fixed to the annular convex portion 24 of the housing 11. The water blocking member 15 is not in direct contact with the rotary body 14. Specifically, the water blocking member 15 forms a non-contact waterproof structure in conjunction with the rotary body 14.

The water blocking member 15 is covered from above by the receiver 35. In this manner, direct insolation on the water blocking member 15 is suppressed. Therefore the water blocking member 15 does not easily deteriorate by sunlight even when it is made of synthetic resin. Moreover, the water blocking member 15 is arranged in a space partitioned by the top plate 40 and the first annular wall 41 of the receiver 35. The water blocking member 15 is formed in an annular shape centered at the vertical axis L1. A through hole 15a is formed in the center of the water blocking member 15.

The water blocking member 15 has an outer circumferential portion 15b, a first inclining portion 15c, and an inner circumferential portion 15d.

The outer circumferential portion 15b covers an outer circumferential portion of the receiver 35 from below. The outer circumferential portion 15b has an outward end of the water blocking member 15 in the radial direction R1. The outer circumferential portion 15b extends in the horizontal direction and is in parallel with the receiver 35. Note that, the outer circumferential portion 15b may incline with respect to the horizontal plane. The outer circumferential portion 15b is arranged, in its plan view, between the first and second annular walls 41 and 42. An edge area of the outer circumferential portion 15b (i.e., outer circumferential end area of the water blocking member 15) has the second opposing area 15e.

The second opposing area 15e is arranged adjacent to the lower portion of the first annular wall 41. The second opposing area 15e is provided to form the first clearance 51 in conjunction with the first opposing area 41a. The first clearance 51 is formed between the second opposing area 15e and the first opposing area 41a. The second opposing area 15e is arranged inward of the first opposing area 41a in the radial directions R1. The second opposing area 15e is arranged to have a predetermined interval D1 from the first opposing area 41a in the radial directions R1. The second opposing area 15e is arranged in parallel with the first opposing area 41a. The interval D1 is fixed in the entire circumferential direction C1.

The first clearance 51 is formed at a position between the housing 11 and the receiver 35. The first clearance 51 extends in the vertical direction Z1 and is open on both sides in the vertical direction Z1. A width of the first clearance 51 in the radial direction R1 is set to the interval D1. The value is set to about a few mm. The interval D1 is suitably set according to an internal gap of the bearing 13, a dimension tolerance of the housing 11, a dimension tolerance of the rotary body 14, and a dimension tolerance of the water blocking member 15. In this manner, the first annular wall 41 is arranged not to be in contact with the water blocking member 15.

A first space 44 is formed continuously to the first clearance 51. The first space 44 is a cylindrical space partitioned by the top plate 40, the first annular wall 41, the outer circumferential portion 15b of the water blocking member 15, and the second annular wall 42. The first space 44 is positioned above the first clearance 51. A second space 45 is formed inward of the first space 44 in the radial direction R1. The second space 45 is a cylindrical space partitioned by the top plate 40, the second annular wall 42, and the inner circumferential portion 15d of the water blocking member 15. The first and second spaces 44 and 45 are partitioned therebetween by the second annular wall 42. The second clearance 52 connecting between the first and second spaces 44 and 45 is formed using the first inclining portion 15c.

The first inclining portion 15c is provided as an intermediate portion of the water blocking member 15 in the radial direction R1. The first inclining portion 15c is arranged to surround the angular convex portion 24. The first inclining portion 15c inclines upwardly, toward inside in the radial direction R1. In other words, the first inclining portion 15c inclines downwardly, toward outside in the radial direction R1. The first inclining portion 15c extends from a position outward of the second annular wall 42 to a position inward thereof in the radial direction R1. With this configuration, the first inclining portion 15c and the second annular wall 42 are arranged to align in the vertical direction Z1.

The first inclining portion 15c has the fourth opposing area 15f. The fourth opposing area 15f is formed in a top surface of the first inclining portion 15c. The fourth opposing area 15f aligns with the third opposing area 42a of the second annular wall 42 in the direction perpendicular to the fourth opposing area 15f. The fourth opposing area 15f is arranged with at least a predetermined interval D2 from the third opposing area 42a. The second clearance 52 is formed between the third opposing area 42a and the fourth opposing area 15f.

The second clearance 52 is provided to suppress water from entering into the second space 45 after passing through the first clearance 51 and the first space 44. The second clearance 52 extends to be open on its both sides in the direction crossing the vertical direction Z1. A width of the second clearance 52 is set to at least the interval D2. The value of the interval D2 is set to be substantially the same as the interval D1.

The second clearance 52 inclines in the direction extending upwardly, toward inside in the radial direction R1. Specifically, the second clearance 52 extends in the direction different from the extending direction of the first clearance 51. In the vertical direction Z1, the position of the second clearance 52 is set higher than that of the first clearance 51. The first inclining portion 15c forming the second clearance 52 is continuous to the inner circumferential portion 15d.

The inner circumferential portion 15d is fixed to the housing 11. The inner circumferential portion 15d has an inner end of the water blocking member 15 in the radial direction R1. The inner circumferential portion 15d extends in the horizontal direction and is in parallel with the receiver 35. The inner circumferential portion 15d is arranged on the annular convex wall 24 of the housing 11. The inner circumferential portion 15d is fixed to an upper face of the annular convex portion 24. In this embodiment, the labyrinth unit 16 is arranged on the inner circumferential portion 15d.

The labyrinth unit 16 is provided to suppress water and water particles from reaching the bearing 13 after passing the second clearance 52. The labyrinth unit 16 is arranged in the second space 45 between the water blocking member 15 and the receiver 35. The labyrinth unit 16 is formed in an annular shape centered at the vertical axis L1.

The labyrinth unit 16 has an oil holder 46, a first partitioning wall 47, and second partitioning walls 48 (contact part).

The oil holder 46 is provided to hold oil 53 and is formed in a groove shape. Specific examples of the oil 53 include liquid oil, and semisolid oils contained in grease. The grease is a lubricant obtained by mixing base oil with a thickener. Specifically, when semisolid oil is used, the oil holder 46 holds the grease. As described above, the oil 53 is either one of liquid and semisolid, and has flowability. The oil holder 46 is fixed to the inner circumferential portion 15d and is fixed to the annular convex potion 24 of the housing 11 via the water blocking member 15.

The oil holder 46 has a pair of side walls 46a and a bottom wall 46b.

The pair of side walls 46a are formed in cylindrical shapes centered at the vertical axis L1 and arranged concentrically to each other. The side walls 46a extend in the vertical direction Z1. The bottom wall 46b is arranged to connect bottom ends of the side walls 46a. The bottom wall 46b is fixed to the inner circumferential portion 15d. The side walls 46a and the bottom wall 46b form a space for holding the oil 53 in conjunction with each other. The bottom wall 46b supports the first partitioning wall 47.

The first partitioning wall 47 is provided to partition the space inside the oil holder 46. The first partitioning wall 47 is formed in a cylindrical shape centering on the vertical axis L1 and extends in the vertical direction Z1. The first partitioning wall 47 is arranged between the side walls 46a and fixed to the bottom wall 46b. In this embodiment, an upper end of the first partitioning wall 47 is set to be at substantially the same position as upper ends of the side walls 46a in the vertical direction Z1. Note that, the first partitioning wall 47 does not need to be formed in a cylindrical shape. For example, the first partitioning wall 47 may be formed by using a plurality of wall members, each having an arc shape centered at the vertical axis L1. The second partitioning walls 48 are arranged adjacent to the first partitioning wall 47.

The second partitioning walls 48 form a labyrinth 49 (zigzag path) in conjunction with the first partitioning wall 47 and the oil holder 46. The second partitioning walls 48 are fixed to the top plate 40 of the receiver 35 and are rotatable about the vertical axis L1 integrally with the receiver 35. The second partitioning walls 48 are arranged from above. The second partitioning walls 48 are provided as a pair. Each of the second partitioning walls 48 is formed in a cylindrical shape centering on the vertical axis L1 and extends in the vertical direction Z1. The second partitioning walls 48 are arranged between the side walls 46a. The walls are arranged in the radial direction R1 in the order of one of the side walls 46a, one of the second partitioning walls 48, the first partitioning wall 47, the other second partitioning wall 48, and the other side wall 46a. Lower ends of the second partitioning walls 48 are arranged in the oil holder 46 and contact the oil 53. With the above configuration, the labyrinth 49 is formed in the labyrinth unit 16.

The labyrinth 49 is provided as a passage that rises up and falls down, toward inside in the radial direction R1. The labyrinth 49 is formed between the oil holder 46 and the second partitioning walls 48. The labyrinth 49 is formed in the entire circumferential direction C1. A part of the labyrinth 49 is filled with the oil 53. The space 50 formed by the space forming surface 23, and the second space 45 are isolated from each other by the labyrinth 49 and the oil 53. The labyrinth unit 16 is provided to prevent water from further entering inside after passing through the first clearance 51. On the other hand, the drainage path 17 is provided to suppress water from entering inside the clearance 51.

Specifically, the drainage path 17 discharges the water that has passed through the gateway 43 described above, to outside the gateway 43. The drainage path 17 is formed below the receiver 35 and below the water blocking member 15. The drainage path 17 is formed in the entire circumferential direction C1. The drainage path 17 is formed using the receiver 35, the water blocking member 15, and the housing 11.

The drainage path 17 includes a first section 61, a second section 62, a third section 63, and a fourth section 64.

The sections are arranged in the radial direction R1 in the order of the first section 61, the second section 62, the third section 63, and the fourth section 64. The first section 61 is provided as an outer-most section of the drainage path 17 in the radial direction R1. On the other hand, the fourth section 64 is provided as an inner-most section of the drainage path 17 in the radial direction R1.

The first section 61 is formed with the lower end of the first annular wall 41 and the second inclining surface 25. The first section 61 is a space open to outside the waterproof rotation mechanism 10. An outer end area of the first section 61 in the radial direction R1 forms the gateway 43 described above. The width of the first section 61 (a space between the lower end of the first annular wall 41 and the second inclining surface 25) in the vertical direction Z1 is set to a few mm or wider, for example. The second section 62 is arranged continuously to the first section 61.

The second section 62 is formed with the outer circumferential portion 15b of the water blocking member 15 and the second inclining surface 25. A space of the second section 62 is positioned between the outer circumferential portion 15b and the second inclining surface 25. The space of the second section 62 is continuous to the first clearance 51. The first clearance 51 is positioned on the second section 62. The space of the second section 62 has narrower width in the vertical direction Z1, toward upstream of the drainage path 17 in the radial direction R1. The third section 63 is arranged continuously to the second section 62.

The third section 63 is formed with the first inclining portion 15c of the water blocking member 15 and the second inclining surface 25. A space of the third section 63 is positioned between the first inclining portion 15c and the second inclining surface 25. The inclination of the first inclining portion 15c is larger than that of the second inclining surface 25 with respect to the horizontal plane. In this manner, the space of the third section 63 has wider width in the vertical direction Z1, toward upstream of the drainage path 17 in the radial direction R1. The fourth section 64 is arranged continuously to the third section 63.

The fourth section 64 is formed with the inner circumferential portion 15d of the water blocking member 15, the second inclining surface 25, and the annular convex portion 24. A space of the fourth section 64 is positioned between the inner circumferential portion 15d and the second inclining surface 25.

The size of the space of the third section 63 and the size of the space of the fourth section 64 are larger than that of the second section 62 so that water that has entered inside the second section 62 easily reaches the third section 63 and then the fourth section 64. Therefore, water can be suppressed from entering inside the first clearance 51.

### [Waterproof Operation of Waterproof Rotation Mechanism]

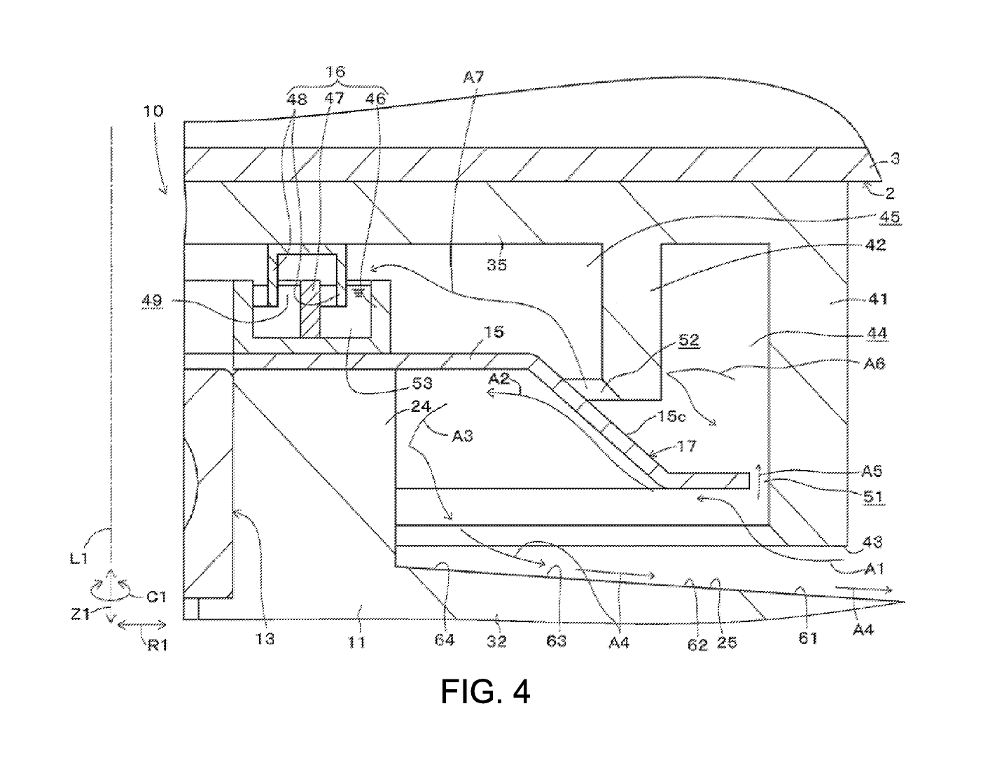

Next, the waterproof operation by the waterproof rotation mechanism 10 is described. FIG. 4 is a cross-sectional view showing the main part of the waterproof rotation mechanism 10 illustrating the waterproof operation in a further enlarged manner. When sea water and/or rain enter the gateway 43 as indicated by the arrow A1 in FIG. 4, the water passes through the space of the first section 61 and enters the second section 62. As indicated by the arrow A2 in FIG. 4, the water in the second section 62 further passes through the space of the third section 63 and reaches the fourth section 64. As indicated by the arrow A3 in FIG. 4, the water in the fourth section 64 bounces on the member forming the fourth section 64 (e.g. the annular convex portion 24). In this manner, as indicated by the arrow A4 in FIG. 4, the water inside the fourth section 64 falls onto the second inclining surface 25 and passes the gateway 43 to be discharged outside the waterproof rotation mechanism 10.

When the flow of water that has entered the second section 62 is strong, a part of the water inside the second section 62 may flow as indicated by the arrow A5 in FIG. 4. Specifically, the part of the water inside the second section 62 passes the first clearance 51 and enters the first space 44 between the receiver 35 and the water blocking member 15. As indicated by the arrow A6 in FIG. 4, the water bounces on the second annular wall 42 and the first inclining portion 15c around the second clearance 52. In this manner, the water that has passed through the first clearance 51 passes the first clearance 51 again to be discharged to the second section 62.

However, when the water flow is strong or when the water particles caused by, for example, wave splash and/or humidity exist, as indicated by the arrow A7 in FIG. 4, the water and/or water particles may pass the second clearance 52. In this case, the water and/or water particles may reach the labyrinth unit 16. However, the labyrinth 49 is blocked by the oil 53 stored in the oil holder 46. Therefore, the water and/or water particles cannot pass the labyrinth 49. Thus, the water and/or water particles does not reach the bearing 13.

According to the waterproof rotation mechanism 10 described above, the receiver 35 and the water blocking member 15 are arranged adjacent to each other via the clearances 51 and 52. The clearances 51 and 52 are narrow clearances for suppressing the water from entering therein. As a result of the existence of the water block member 15, the water is suppressed from entering inside the waterproof rotation mechanism 10. In this manner, the waterproof rotation mechanism 10 can exert a sufficient waterproofing effect. Moreover, the water blocking member 15 is arranged below the receiver 35. In this manner, the water flowing toward the receiver 35 therebelow can be received by the water blocking member 15. Thus, water can be suppressed from reaching the rotary body 14. Therefore, the waterproofing effect can be exerted more sufficiently and surely. Moreover, the water blocking member 15 for exerting the waterproofing effect does not directly contact with the rotary body 14. Specifically, the water blocking member 15 and the rotary body 14 are not in contact with each other. Therefore, wearing and deterioration of the water blocking member 15 due to, for example, friction between the water blocking member 15 and the rotary body 14 do not occur. In this manner, the waterproofing effect can be exerted for a long term. Thus, the waterproof rotation mechanism 10 having the rotary body 14 that is rotatable about the vertical axis L1 can exert the sufficient waterproofing effect for a long term.

Additionally, according to the waterproof rotation mechanism 10 of this embodiment, the first inclining portion 15c of the water blocking member 15 extends downwardly, toward outside in the radial direction R1. In this manner, water on the first inclining portion 15c can easily flow downstream. As a result, the water attached on the first inclining portion 15c can easily be discharged outside the waterproof rotation mechanism 10.

Additionally, according to the waterproof rotation mechanism 10 of this embodiment, the second inclining surface 25 of the housing 11 extends downwardly, toward outside in the radial direction R1. In this manner, water on the second inclining surface 25 can easily flow downstream. As a result, the water on the second inclining surface 25 can easily be discharged outside the waterproof rotation mechanism 10.

Moreover, according to the waterproof rotation mechanism 10 of this embodiment, the first clearance 51 extends in the vertical direction Z1. In this manner, even if water enters the first clearance 51, the water flows upwardly in the vertical direction Z1. Therefore, water is further surely suppressed from entering inside the space between the receiver 35 and the water blocking member 15.

Additionally, according to the waterproof rotation mechanism 10 of this embodiment, the second opposing area 15e of the water blocking member 15 is arranged in parallel with the first opposing area 41a of the first annular wall 41 and forms the first clearance 51 in conjunction with the first opposing area 41a. Thus, the first clearance 51 can be formed with the easy configuration such that the first opposing area 41a is arranged in parallel with the second opposing area 15e.

Additionally, according to the waterproof rotation mechanism 10 of this embodiment, the plurality of clearances 51 and 52 are formed. In this manner, water can further surely be suppressed from entering inside the waterproof rotation mechanism 10, especially inside the bearing 13, by the plurality of clearances 51 and 52.

Moreover, according to the waterproof rotation mechanism 10 of this embodiment, the plurality of clearances 51 and 52 are formed in concentric circles centered at the vertical axis L1. In this manner, water can further surely be suppressed from entering inside the bearing 13.

Additionally, according to the waterproof rotation mechanism 10 of this embodiment, the second partitioning walls 48 of the labyrinth unit 16 form the walls for suppressing water from entering inside, in conjunction with the oil 53. By the walls, water, especially water particles, can be suppressed from entering inside.

Additionally, according to the waterproof rotation mechanism 10 of this embodiment, the labyrinth 49 is formed. In this manner, the effect of blocking water and water particles by the labyrinth unit 16 can further be increased.

Moreover, according to the waterproof rotation mechanism 10 of this embodiment, the drainage path 17 is formed. Therefore, the water that has reached around the water blocking member 15 is discharged outside the waterproof rotation mechanism 10. Thus, the waterproof rotation mechanism 10 can further surely exert the sufficient waterproofing effect.

Furthermore, according to the waterproof rotation mechanism 10 of this embodiment, the drainage path 17 is open outwardly in the radial direction R1, to the space outside. Moreover, the drainage path 17 has the third section 63 of which the width in the vertical direction Z1 is wider, toward inside in the radial direction R1. In this manner, the water that has entered the drainage path 17 passes the third section 63 and bounces in the wide space (fourth section 64) positioned on the inner side in the waterproof rotation mechanism 10 within the drainage path 17. The water bounced within the drainage path 17 flows toward the space outside thereafter. In this manner, water inside the drainage path 17 can smoothly be discharged.

As above, the embodiment of the present invention is described. The present invention is not limited to the above embodiment, and may be modified within the scope of the claims. For example, it may be modified as follows to be implemented.

### [Modifications]

(1) In the above embodiment, the example in which the water blocking member has the first inclining portion, and the housing has the second inclining surface is described; however, it is not limited to this. For example, at least one of the first inclining portion and the second inclining surface may be formed to extend in the horizontal direction.

(2) In the above embodiment, the example in which the first clearance extends in the vertical direction is described; however, it is not limited to this. For example, the first clearance may extend in the direction crossing the vertical direction.

(3) In the above embodiment, the example in which the two clearances are formed is described; however, it is not limited to this. For example, the second clearance may be omitted. Moreover, the number of clearances may be three or more.

(4) In the above embodiment, the example in which the labyrinth unit is formed is described; however, it is not limited to this. For example, the labyrinth unit may be omitted.

(5) In the above embodiment, the example in which the drainage path has the third section having wider width in the vertical direction, toward inside in the radial direction, is described; however, it is not limited to this. For example, the drainage path may have a fixed width in the vertical direction.

(6) In the above embodiment, the example in which the waterproof rotation mechanism is provided to the radar antenna device is described; however, it is not limited to this, and may be provided to other devices.

The present invention can be widely applied to the waterproof rotation mechanism that is a rotation mechanism having a waterproof structure, and the radar antenna device.

In the foregoing specification, specific embodiments of the present invention have been described. However, one of ordinary skill in the technique appreciates that various modifications and changes can be performed without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A waterproof rotary mechanism, comprising:
a stationary part;
a rotary part having a receiver arranged above the stationary part, and rotatably supported by the stationary part on a vertical axis as a rotating center thereof; and
a clearance forming part fixed to the stationary part and arranged between the stationary part and the receiver, wherein a clearance for suppressing water from entering therein is formed between the receiver and the clearance forming part.

2. The mechanism of claim 1, wherein the clearance forming part has a first inclining portion, the first inclining portion being formed to extend downwardly toward outside in a radial direction of the rotary part.

3. The mechanism of claim 1, wherein the stationary part has a second inclining portion arranged below the clearance forming part, the second inclining portion being formed to extend downwardly toward outside in a radial direction of the rotary part.

4. The mechanism of claim 1, wherein the clearance formed between the receiver and the clearance forming part extends in the vertical direction.

5. The mechanism of claim 4, wherein the receiver has a first opposing portion, while the clearance forming part has a second opposing portion, and
wherein the second opposing portion is arranged in parallel with the first opposing portion, forms the clearance in conjunction with the first opposing portion, and is arranged inward of the first opposing portion in a radial direction of the rotary part.

6. The mechanism of claim 1, wherein the clearance formed between the receiver and the clearance forming part includes a plurality of clearances for suppressing water from entering therein.

7. The mechanism of claim 6, wherein the plurality of clearances are formed in shapes of concentric circles centered at the vertical axis, respectively.

8. The mechanism of claim 1, further comprising:
an oil holder arranged between the clearance forming part and the receiver and supported by the stationary part, and for holding oil therein; and
a contact part fixed to the receiver and contacting the oil in the oil holder.

9. The mechanism of claim 8, wherein a part of the contact part is arranged within the space in the oil holder; and
wherein a labyrinth is formed between the oil holder and the contact part.

10. The mechanism of claim 1, further comprising a drainage path formed by using the clearance forming part and the stationary part, and for discharging the water.

11. The mechanism of claim 10, wherein the drainage path extends outwardly in a radial direction of the rotary part to be open to outside the waterproof rotation mechanism, and has a section having wider width in the vertical direction, toward inside in the radial direction of the rotary part.

12. A radar antenna device, comprising:
the waterproof rotation mechanism of claim 1; and
an antenna fixed to the receiver and rotatable on the vertical axis as a rotating center thereof.
